(19) United States
(12) Patent Application Publication
(10) Pub. No.: US 2013/0115358 A1
(43) Pub. Date: May 9, 2013

(54) BAKED FOOD PRODUCTS PREPARED WITH CARBONATED LIQUIDS AND METHODS OF MAKING THE SAME

(71) Applicant: Catherine V. Seeley, Bel Air, MD (US)

(72) Inventor: Catherine V. Seeley, Bel Air, MD (US)

(21) Appl. No.: 13/628,936

(22) Filed: Sep. 27, 2012

Related U.S. Application Data
(60) Provisional application No. 61/540,762, filed on Sep. 29, 2011.

(51) Int. Cl. A21D 10/04

(52) U.S. Cl. CPC A21D 10/04
USPC 426/553; 426/496

(57) ABSTRACT

Described herein are baked food products prepared using a carbonated liquid in combination with an dry ingredients mixture that includes flour, a leavening agent, and a solid or semi-solid fat component. The use of carbonated liquid in preparing the baked food products allows them to be free of other ingredients, particularly liquid ingredients, including liquid oils, milk, and eggs, while maintaining a quality similar to baked food products prepared using such ingredients. Baked food products according to this invention are therefore acceptable for consumption by persons for whom consumption of the omitted conventional ingredient(s) would be unsuitable, such as persons having food allergies to the omitted ingredient(s). Also described are kits including the ingredients for preparing baked food products of the invention, and methods of making baked food products according to the invention.

### RELATED APPLICATION DATA

The present United States Patent Application claims priority to U.S. Provisional Patent Application No. 61/540,762; filed Sep. 29, 2011, the disclosure of which is hereby incorporated by reference in its entirety.

### FIELD OF THE INVENTION

The present invention relates to baked food products, particularly baked food products prepared with carbonated liquid and which may be free of other ingredients, particularly liquid ingredients, including liquid oils, eggs, and milk. The use of the carbonated liquid permits the omission of ingredients which may cause food allergies or otherwise be undesirable for consumption, without adversely affecting the taste or other characteristics of the baked food products.

### BACKGROUND OF RELATED TECHNOLOGY

Traditional baked food products, particularly baked confectionaries such as cookies, cakes, cupcakes, brownies and the like, are typically made using sugar, flour, and eggs, and typically include other ingredients such as milk and vegetable oils to impart moisture and texture to the final product. Eggs are particularly important as they serve to bind the other ingredients together, and provide leavening, flavor, color, texture, and richness to the batter. Together with flour, eggs are the main structural ingredients in baking.

Traditional baked food products made with eggs and/or milk, however, are unsuitable for consumption by people with food allergies and/or digestive intolerance to such ingredients, and/or when reduced calorie, fat or cholesterol baked food products are desired.

Accordingly, there exists a need in the art for substitutes for conventional baking ingredients which will render baked food products suitable for consumption by such persons.

In this regard, efforts in the art to discover and develop suitable substitutes have resulted, for example, in the use of natural and artificial sweeteners as sugar substitutes, applesauce and other ingredients as substitutes for shortening and vegetable oils, and reduced-cholesterol egg products and eggless egg products (such as powdered or spray-dried formulations) as egg substitutes. Substitutions for other ingredients are also known in the art.

Despite the longstanding need and efforts in the art to develop such substitutes, however, they are generally insufficient to adequately replicate the function(s) of the ingredient for which they are being substituted, typically resulting in baked food products of reduced quality, particularly with respect to the taste and texture of the final product.

Accordingly, there exists a need in the art for new and improved baked food products, including baked confectionaries, and methods for their preparation, which address these problems, and it is to these objects that the present invention is directed.

### SUMMARY OF THE INVENTION

Generally speaking, the present invention addresses certain problems and needs in the art by providing baked food products, including, for example and without limitation, cakes, cookies, muffins and brownies, which are prepared from a batter that includes flour, a leavening agent, a solid or semi-solid fat component, and a carbonated liquid. It has unexpectedly been found in the present invention that the use of carbonated liquid in preparing the batter allows for the omission, when desired, of certain ingredients, in particular certain liquid ingredients, that are conventionally used in preparing baked food products, including liquid oils, eggs, milk, and other liquid ingredients, without detracting from the taste, texture, and other characteristics of the resulting baked food products.

In certain non-limiting embodiments, the present invention is directed to a batter for preparing a baked food product that includes flour; a leavening agent; a solid or semi-solid fat component; and a carbonated liquid.

In certain other non-limiting embodiments, the flour of a batter according to the present invention may be selected from the group consisting of white flour; wheat flour; corn flour; and gluten-free flour.

In certain other non-limiting embodiments, the leavening agent of a batter according to the present invention may be selected from the group consisting of baking soda (sodium bicarbonate); baking powder; dicalcium phosphate; sodium aluminum phosphate; and monocalcium phosphate.

In certain other non-limiting embodiments, the solid or semi-solid fat component of a batter according to the present invention may be selected from the group consisting of shortening; lard; margarine; coconut oil; palm oil; partially hydrogenated soybean oil; and cottonseed oil.

In certain other non-limiting embodiments, the shortening of a batter according to the present invention may be vegetable oil shortening.

In certain other non-limiting embodiments, the carbonated liquid of a batter according to the present invention may be selected from the group consisting of club soda; seltzer water; beverages with artificial sweeteners; and sugared beverages.

In certain other non-limiting embodiments, a batter according to the present invention may further include one or more ingredients selected from the group consisting of sugar; butter; salt; a thickening agent; dried eggs; dried milk; a coloring agent; a flavoring agent; and combinations thereof.

In certain other non-limiting embodiments, the thickening agent of a batter according to the present invention may be selected from the group consisting of a starch; fruit pectin; xanthan gum; cellulose gum; and guar gum.

In certain other non-limiting embodiments, a batter according to the present invention may be substantially free of eggs.

In certain other non-limiting embodiments, of a batter according to the present invention may be substantially free of milk.

In certain other non-limiting embodiments, a batter according to the present invention may be substantially free of liquid ingredients other than carbonated liquid.

In certain other non-limiting embodiments, the present invention is directed to a baked food product prepared from a batter according to the present invention.

In certain other non-limiting embodiments, a baked food product prepared from a batter according to the present invention may be selected from the group consisting of a cake; a cookie; a muffin; and a brownie.

In certain other non-limiting embodiments, the present invention is directed to a kit for preparing a baked food product, the kit including (a) a first package including a dry ingredients mixture that includes flour; a leavening agent; and a solid or semi-solid fat component; and (b) a second package including a carbonated liquid.

In certain other non-limiting embodiments, the present invention is directed to a kit for preparing a baked food product, the kit including (a) a first package including a dry ingredients mixture that includes flour and a leavening agent; and (b) a second package including a carbonated liquid.

In certain other non-limiting embodiments, the flour of a kit according to the present invention may be selected from the group consisting of white flour; wheat flour; corn flour; and gluten-free flour.

In certain other non-limiting embodiments, the leavening agent of a kit according to the present invention may be selected from the group consisting of baking soda (sodium bicarbonate); baking powder; dicalcium phosphate; sodium aluminum phosphate; and monocalcium phosphate.

In certain other non-limiting embodiments, the solid or semi-solid fat component of a kit according to the present invention may be selected from the group consisting of shortening; lard; margarine; coconut oil; palm oil; partially hydrogenated soybean oil; and cottonseed oil.

In certain other non-limiting embodiments, the shortening of a kit according to the present invention may be vegetable oil shortening.

In certain other non-limiting embodiments, the carbonated liquid of a kit according to the present invention may be selected from the group consisting of club soda; seltzer water; beverages with artificial sweeteners; and sugared beverages.

In certain other non-limiting embodiments, the dry ingredients mixture of a kit according to the present invention may further include one or more ingredients selected from the group consisting of sugar; salt; a thickening agent; dried eggs; dried milk; a coloring agent; a flavoring agent; and combinations thereof.

In certain other non-limiting embodiments, the thickening agent of a kit according to the present invention may be selected from the group consisting of a starch; fruit pectin; xanthan gum; cellulose gum; and guar gum.

In certain other non-limiting embodiments, the dry ingredients mixture of a kit according to the present invention may be substantially free of eggs.

In certain other non-limiting embodiments, the dry ingredients mixture of a kit according to the present invention may be substantially free of milk.

In certain other non-limiting embodiments, the first package of a kit according to the present invention may be affixed to the second package of a kit according to the present invention.

In certain other non-limiting embodiments, a kit according to the present invention may further include a third package, wherein the first and second packages of the kit according to the present invention are each provided within the third package.

In certain other non-limiting embodiments, a kit according to the present invention may further include instructions for preparing a baked food product from the dry ingredients mixture and the carbonated liquid of the kit according to the present invention.

In certain other non-limiting embodiments, the ratio of the dry ingredients mixture to the carbonated liquid in a kit according to the present invention may be about one and one-half to one (1.5:1).

In certain other non-limiting embodiments, the present invention is directed to a baked food product prepared from a kit according to the present invention in which the ratio of the dry ingredients mixture to the carbonated liquid may be about one and one-half to one (1.5:1), wherein the baked food product may be a cake or a muffin.

In certain other non-limiting embodiments, the ratio of the dry ingredients mixture to the carbonated liquid in a kit according to the present invention may be about two and one-half to one (2.5:1).

In certain other non-limiting embodiments, the present invention is directed to a baked food product prepared from a kit according to the present invention in which the ratio of the dry ingredients mixture to the carbonated liquid may be about two and one-half to one (2.5:1), wherein the baked food product may be a brownie.

In certain other non-limiting embodiments, the present invention is directed a method for preparing a baked food product that includes the steps of: (a) mixing flour; a leavening agent; a solid or semi-solid fat component; and a carbonated liquid, to prepare a batter; and (b) baking the batter of step (a).

In certain other non-limiting embodiments, in a method for preparing a baked food product according to the present invention, the flour; the leavening agent; and the solid or semi-solid fat component may be provided together in a dry ingredients mixture, wherein the dry ingredients mixture may be mixed with the carbonated liquid.

In certain other non-limiting embodiments, in a method for preparing a baked food product according to the present invention, the ratio of the dry ingredients mixture to the carbonated liquid used in the method may be about one and one-half to one (1.5:1).

In certain other non-limiting embodiments, the present invention is directed to a baked food product prepared according to a method of the present invention in which the ratio of the dry ingredients mixture to the carbonated liquid used in the method may be about one and one-half to one (1.5:1), wherein the baked food product may be a cake or a muffin.

In certain other non-limiting embodiments, the present invention is directed to a baked food product prepared according to a method of the present invention in which the ratio of the dry ingredients mixture to the carbonated liquid used in the method may be about one and one-half to one (1.5:1), wherein the baked food product may be a cake or a muffin which is substantially free of eggs.

In certain other non-limiting embodiments, the present invention is directed to a baked food product prepared according to a method of the present invention in which the ratio of the dry ingredients mixture to the carbonated liquid used in the method may be about one and one-half to one (1.5:1), wherein the baked food product may be a cake or a muffin which is substantially free of milk.

In certain other non-limiting embodiments, in a method for preparing a baked food product according to the present invention, the ratio of the dry ingredients mixture to the carbonated liquid used in the method may be about two and one-half to one (2.5:1).

In certain other non-limiting embodiments, the present invention is directed to a baked food product prepared according to a method of the present invention in which the ratio of the dry ingredients mixture to the carbonated liquid used in the method may be about two and one-half to one (2.5:1), wherein the baked food product may be a brownie.

In certain other non-limiting embodiments, the present invention is directed to a baked food product prepared according to a method of the present invention in which the ratio of the dry ingredients mixture to the carbonated liquid used in the method may be about two and one-half to one (2.5:1), wherein the baked food product may be a brownie which is substantially free of eggs.

In certain other non-limiting embodiments, the present invention is directed to a baked food product prepared according to a method of the present invention in which the ratio of the dry ingredients mixture to the carbonated liquid used in the method may be about two and one-half to one (2.5:1), wherein the baked food product may be a brownie which is substantially free of milk.

In certain other non-limiting embodiments, the present invention is directed to a method for preparing a baked food product according to the present invention that further includes the step of mixing one or more ingredients selected from the group consisting of sugar; butter; salt; a thickening agent; dried eggs; dried milk; a coloring agent; a flavoring agent; and combinations thereof.

In certain other non-limiting embodiments, the present invention is directed a method for preparing a baked food product according to the present invention, that includes the steps of (a) providing a dry ingredients mixture that includes flour; a leavening agent; and a solid or semi-solid fat component; (b) adding a carbonated liquid to the dry ingredients mixture; (c) mixing the carbonated liquid and the dry ingredients mixture, to prepare a batter; and (d) baking the batter.

In certain other non-limiting embodiments, in a method for preparing a baked food according to the present invention the batter may be substantially free of liquid ingredients other than carbonated liquid.

In certain other non-limiting embodiments, in a method for preparing a baked good according to the present invention the batter may be substantially free of liquid oils; milk; and eggs.

In certain other non-limiting embodiments, in a method for preparing a baked food product according to the present invention the dry ingredients mixture may further include one or more ingredients selected from the group consisting of salt; starch; a thickening agent; dried eggs; dried milk; a coloring agent; a flavoring agent; and combinations thereof.

In certain other non-limiting embodiments, the present invention is directed to a baked food product prepared according to a method for preparing a baked good according to the present invention.

In certain other non-limiting embodiments, the present invention is directed to a baked food product prepared according to a method for preparing a baked good according to the present invention, wherein the baked food product is a cake; a cookie; a muffin; or a brownie.

### DETAILED DESCRIPTION OF THE INVENTION

Generally speaking, and as discussed in greater detail in the illustrative and non-limiting examples provided herein, the present invention is directed to baked food products (such as cakes, cookies, muffins, brownies, and so forth) prepared from a batter or dough (such terms being used interchangeably and synonymously herein) that includes flour, a leavening agent, a solid or semi-solid fat component, and a carbonated liquid. The batter may further include other conventional baking ingredients.

It has unexpectedly been found in the present invention that the use of carbonated liquid in preparing the batter allows for the omission, when desired, of certain ingredients conventionally used in preparing baked food products, including liquid oils, eggs, milk, and other liquid ingredients, without detracting from the taste, texture and other characteristics of the resulting baked food products.

As a result, baked food products according to the present invention may be lower in calories than conventional baked food products and/or may be suitable for consumption by persons with food allergies to one or more of the ingredients which may be omitted due to the use of carbonated liquid in preparing the batter from which the baked food products of the present invention are formed, or by persons for whom consumption of the omitted ingredients is otherwise undesirable.

As used in the present invention, “baked food products” are understood to include, for example and without limitation, any foodstuff produced through a baking process (for example and without limitation, cooking by dry heat acting by convection, typically over prolonged periods), and particularly includes baked confectionary products, such as cookies, cakes, cupcakes, brownies and the like, which are conventionally prepared from a batter of mixed ingredients that includes sugar, flour and eggs.

As used in the present invention, “flour” is understood to include, for example and without limitation, white flours; wheat flours, including, but not limited to the following varieties of wheat flour: bleached, unbleached, white wheat, all purpose, bread flour, cake flour, gluten flour, bread flour, buckwheat, organic, instant, self-rising, pastry, semolina, graham flour, whole wheat flour, whole wheat bread flour, enriched flour, durum flour, and kamut flour; non-wheat flours, including, but not limited to the following varieties of non-wheat flours: rice flour, potato flour, nut flours, teff flour, spelt flour, corn flour, amaranth flour, barley flour, cornmeal flour, legume flour, millet flour, oat flour, quinoa flour, rye flour, soy flour, soya flour, and triticale flour; gluten-free flours; and other types of flours known in the art, and in particular those conventionally used in dry ingredient mixes for preparing baked food products.

As used in the present invention, “leavening agent” is understood to include, for example and without limitation, any ingredient which serves to incorporate gas bubbles into the batter to lighten and soften the resulting baked food product, and includes, for example and without limitation, conventional leavening agents such as baking soda (sodium bicarbonate), baking powder; dicalcium phosphate, sodium aluminum phosphate, and monocalcium phosphate.

As used in the present invention, “solid or semi-sold fat component” is understood to include, for example and without limitation, fat ingredients which are not in liquid form and which are conventionally found in dry mixtures for preparing baked food products, and includes, for example and without limitation, shortenings, including vegetable oil shortening; margarines; lards; and oils, including, without limitation, coconut oil, palm oil, partially hydrogenated soybean oil, and cottonseed oil.

As used in the present invention, the term “carbonated liquid(s)” is understood to include, for example and without limitation, any liquid into which carbon dioxide gas has been dissolved, which is typically achieved, for example and without limitation, through a high pressurization process. Examples of carbonated liquids which may be used in the present invention include, for example and without limitation, carbonated beverages, such as seltzer water, club soda, beverages with artificial sweeteners, and flavored carbonated liquids, including those containing sugar.

As used in the present invention, to state that a baked food product, batter, or method step is “substantially free” of an ingredient is understood to mean, for example and without limitation, that such ingredient is not intentionally added, but may be present in trace amounts (for example, when introduced due to the presence of such ingredient on a cooking surface, utensil, etc. used in preparing baked food products according to the present invention).

As used in the present invention, the term “egg(s)” is understood to include, for example and without limitation, whole eggs (including those having white or brown shells, and of any origin), as well as egg substitutes that include egg components, such as, without limitation, egg white (albumin) and egg yolk, and which may be provided in various forms (such as powdered or spray-dried).

As used in the present invention, the term “milk” is understood to include, for example and without limitation, whole milk; reduced calorie milk; soy milk; and products that include milk components, regardless of whether as a wet or dry product, and specifically including, but not limited to, cows milk and goats milk.

Baked food products prepared according to the present invention may include other conventional ingredients, for example and without limitation, salt, baking powder, vegetable oil/shortening, butter, milk, starches and other thickeners, and flavorings, such as incorporated flavorings including vanilla extract, chocolate, coconut, spices, juices, and so forth, and icings which are applied to the food products after baking Furthermore, they may be prepared from scratch (i.e., mixing each of the individual ingredients) or from a mix in which certain of the ingredients are provided together for convenience (for example, a cake mix which may include, among other ingredients, sugar, flour, vegetable oil shortening, and leavening agents, and which may optionally include milk products).

As discussed supra, the present invention is directed to the unexpected finding that carbonated liquid may be substituted for eggs, and may optionally be substituted for other liquid ingredients as well, in conventional baked food product recipes without substantially affecting the quality of the resulting product; the carbonated liquid serving as an acceptable substitute with respect to leavening and other functions otherwise served by the use of eggs (as well as any other omitted ingredients) in the baking process. As a result, baked food products according to the present invention are of a quality substantially similar to those prepared according to conventional recipes that include eggs and other liquid ingredients (with regard to taste and texture, for example), but are suitable for consumption by persons for whom the consumption of the omitted ingredients is unsuitable. The use of carbonated liquid in preparing baked food products according to the present invention also optionally permits the omission of milk and/or other liquid ingredients traditionally used in baked food product recipes (including, for example and without limitation, liquid vegetable oil, non-carbonated water, and so forth).

In certain exemplary, non-limiting embodiments, such baked food products according to the present invention may be prepared as illustrated in the following Examples. It is understood that those of skill in the art will be able to modify the recipes set forth in the following Examples, including modifications and substitutions to the ingredients, in order to prepare baked food products having certain desired characteristics, including but not limited to modifications affecting the taste, texture, color, and so forth of the baked food products, and which are therefore within the scope of the present invention. It is further understood that, while cake mixtures discussed herein are typically provided as dry cake mixtures, such discussion is not to be construed as a limitation on the scope of the present invention.

Moreover, it is to be understood that the present invention may be used with many types of dry ingredient mixes (including those of different brands and from different manufacturers) for example and without limitation dry ingredient mixes for producing cakes, brownies, muffins, pancakes and so forth, and/or may be used with mixes to produce products free of certain allergens (such as, for example and without limitation, products that are free of gluten and/or peanuts), and may also be used with organic mixes.

Furthermore, based on the teachings provided herein, those of skill in the art will be able to determine the appropriate amount of carbonated liquid to be used with such mixes in order to produce a suitable baked food product. For example, as illustrated in certain non-limiting examples below, a typical store-bought box of cake mix that includes about eighteen and one-quarter (18.25) ounces of dry ingredients mix may be combined with twelve (12) ounces of carbonated liquid to produce a suitable baked food product according to the present invention. It has also been found that store-bought boxes of cake mix that include about sixteen and one-quarter (16.25) ounces of dry ingredient mix may be combined with twelve (12) ounces of carbonated liquid to provide a suitable baked food product according to the present invention, and, again, one skilled in the art will be able to modify the amount of carbonated liquid as necessary to produce a desired baked food product according to the present invention

Accordingly, from the teachings provided herein, one of skill in the art will understand that, in certain non-limiting embodiment, baked food products of the present invention may be prepared using a dry ingredients mixture to carbonated liquid ratio of about one and one-half to one (1.5:1) [with a variance of +/− about ten percent (10%) dry ingredients mixture per ounce of carbonated liquid].

It has been found in the present invention that this ratio of about one and one-half to one (1.5:1) results in a batter similar in consistency to typical pancake, cake and muffin batters, and therefore this ratio is particularly desirable for preparing such baked food products.

For brownies, it has been found in the present invention that a mixture of about one (1) ounce chocolate cake mixture+about one and one-half (1.5) ounces brownie mixture per one (1) ounce of carbonated liquid is desirable, for a combined dry ingredients mixture to carbonated liquid ratio of about two and one-half to one (2.5:1) [with a variance of +/− about ten percent (10%) combined dry ingredients mixture per ounce of carbonated liquid]. However, as will be appreciated by those of skill in the art, this ratio may be adjusted as necessary to suit individual brownie tastes, textures, and so forth.

As is well known in the art, the batter prepared from the mixture of ingredients, including those described in the following Examples, is to be baked at a temperature and for a time necessary to prepare a final product suitable for consumption. Therefore, this final baking step is not necessarily recited in the Examples below. Unless stated otherwise, all degrees are in Fahrenheit.

### Example 1

In one embodiment, baked food products according to the present invention are prepared using the following ingredients, and according to the following steps:

Step 1. Mix the following ingredients in a first bowl:
three (3) cups cake flour
two (2) cups baker's sugar
two (2) teaspoons baking powder
two (2) teaspoons baking soda
one and one-quarter (1¼) teaspoons salt
one-half (½) cup shortening

Step 2. Mix the following ingredients in a second bowl:
two (2) teaspoons vanilla
two (2) teaspoons butter flavoring
ten (10) drops yellow food coloring

Step 3. Add the contents of the first bowl to the second bowl.

Step 4. Add twelve (12) ounces of seltzer to the entire mixture in the second bowl.

### Example 2

In another, non-limiting embodiment, baked food products according to the present invention are prepared using the following ingredients, and according to the following steps:

Step 1. Mix the following ingredients in a first bowl:
three and one-half (3½) cups cake flour
two and two-thirds (2⅔) cups baker's sugar
two (2) teaspoons baking powder
two (2) teaspoons baking soda
one and one-quarter (¼) teaspoons salt
one-half (½) cup shortening

Step 2. Mix the following ingredients in a second bowl:
two (2) teaspoons vanilla
two (2) teaspoons butter flavoring
ten (10) drops yellow food coloring

Step 3. Add the contents of the first bowl to the second bowl.

Step 4. Add twelve (12) ounces of seltzer to the entire mixture in the second bowl.

### Example 3

In another, non-limiting embodiment, baked food products according to the present invention are prepared using the following ingredients, and according to the following steps:

Step 1. Mix the following ingredients into a fine powder in a first bowl, and store refrigerated:
five (5) cups flour
two (2) tablespoons+two (2) teaspoons baking powder
two and one-half (2½) teaspoons salt
two and one-half (2½) cups sugar
one-half (½) cup+two (2) tablespoons nonfat dry milk
one and one-quarter (1¼) cups oil

Step 2. Mix the following ingredients in a second bowl:
four (4) cups of the refrigerated mixture from the first bowl
twelve (12) ounces of seltzer
two (2) teaspoons vanilla
pinch of salt
one-quarter (¼) cup of sugar

### Example 4

In another, non-limiting embodiment, baked food products according to the present invention are prepared using the following ingredients, and according to the following steps:

Step 1. Mix the following ingredients in a first bowl:
seven and one-half (7½) cups sifted flour
one (1) tablespoon salt
four and one-half (4¼) cups sugar
four (4) tablespoons double acting RUMFORD brand baking powder
three-quarter (¾) cup butter flavored CRISCO brand shortening

Step 2. Mix the following ingredients in a second bowl:
seven (7) cups of the mixture from the first bowl
twelve (12) ounces of seltzer

### Example 5

In another, non-limiting embodiment, baked food products according to the present invention are prepared using the following ingredients, and according to the following steps:

Step 1. Mix the following ingredients in a first bowl:
one-half (½) cup CRISCO brand shortening
two and one-half (2½) teaspoons butter flavoring
two (2) teaspoons vanilla
one and one-half (1½) teaspoons salt
ten (10) drops yellow food coloring

Step 2. Mix the following ingredients in a second bowl:
three and three-quarters (3¾) cups cake flour
two (2) tablespoons RUMFORD brand baking powder
two and one-quarter (2¼) cup bakers sugar

Step 3. Add mixture in the second bowl to the mixture in the first bowl.

Step 4. Add twelve (12) ounces seltzer to the entire mixture in the first bowl.

### Example 6

In another, non-limiting embodiment, baked food products according to the present invention are prepared using the following ingredients, and according to the following steps:

Step 1. Mix the following ingredients in a first bowl:
one-half (½) cup CRISCO brand shortening
two (2) teaspoons butter flavor
two (2) teaspoons vanilla
two (2) teaspoons salt
eight (8) drops yellow food coloring

Step 2. Mix the following ingredients in a second bowl:
three and three-quarters (3¼) cup all purpose flour
two (2) tablespoons baking powder
two (2) cups bakers sugar

Step 3. Add mixture in the second bowl to the mixture in the first bowl.

Step 4. Add twelve (12) ounces seltzer to the entire mixture in the first bowl.

### Example 7

In another, non-limiting embodiment, baked food products according to the present invention are prepared using the following ingredients, and according to the following steps:

Step 1. Mix the following ingredients in a first bowl:
one-half (½) cup CRISCO brand shortening
one (1) tablespoon butter flavor
one (1) tablespoon vanilla flavor
one and one-half (1½) teaspoons salt
nine (9) drops yellow food coloring

Step 2. Mix the following ingredients in a second bowl:
three and one-half (3½) cups all purpose flour
one (1) tablespoon baking soda
one (1) tablespoon baking powder
two and one-half (2½) cups regular sugar

Step 3. Add mixture in the second bowl to the mixture in the first bowl.

Step 4. Add twelve (12) ounces seltzer to the entire mixture in the first bowl.

### Example 8

In another, non-limiting embodiment, baked food products according to the present invention are prepared using the following ingredients, and according to the following steps:

Step 1. Mix the following ingredients:

three-quarter (¾) cup (5.25 ounces) CRISCO brand shortening
two (2) tablespoons vanilla extract;
one-quarter (¼) cup corn syrup;
fourteen (14) ounces all purpose flour;
seventeen (17) ounces sugar;
one (1) tablespoon baking powder;
one (1) teaspoon salt; and
four (4) tablespoons cornstarch.

Step 2. Add fourteen (14) ounces seltzer to the entire mixture.

### Example 9

### Traditional Yellow Cake

In another, non-limiting embodiment, baked food products according to the present invention are prepared using the following ingredients, and according to the following steps:

Cake Ingredients:
one (1) box DUNCAN HINES brand Yellow Cake Mix [about eighteen and one-quarter (18.25) ounces] (includes: sugar; enriched bleached wheat flour; vegetable oil shortening; leavening agents (sodium bicarbonate, dicalcium phosphate, sodium aluminum phosphate, monocalcium phosphate), wheat starch, salt, dextrose, polyglycerol esters of fatty acids, partially hydrogenated soybean oil, cellulose gum, artificial flavors, xanthan gum, maltodextrin, modified cornstarch, and coloring agents)
twelve (12) ounces seltzer water

Cake Preparation:

Place seltzer in mixing bowl and add mix. Mix on low for thirty seconds and increase to medium-high for an additional two (2) minutes. Prepare two (2), eight (8) inch pans by lining with parchment paper and then generously spraying with vegetable cooking spray. Divide mix between pans and bake at three hundred and fifty (350) degrees for forty-five (45) minutes, or until toothpick inserted in center comes out clean.

For cupcakes, line muffin tin with cupcake papers and spray one (1) quick squirt of vegetable oil cooking spray into each paper. Divide batter evenly to make twenty-four cupcakes. Bake cupcakes for twenty-two (22) minutes at three hundred and twenty-five (325) degrees in a convection oven or at three hundred and fifty (350) degrees if convection is not available.

Allow to cool completely before de-panning cake. Be sure cake or cupcakes are completely cool before applying frosting.

### Example 10

### Chocolate Cake

In another, non-limiting embodiment, baked food products according to the present invention are prepared using the following ingredients, and according to the following steps:

Cake Ingredients:
one (1) box DUNCAN HINES brand Devil's Food Cake Mix [about eighteen and one-quarter (18.25) ounces] (includes: sugar; enriched bleached wheat flour; vegetable oil shortening; cocoa powder; leavening agents (sodium bicarbonate, dicalcium phosphate, sodium aluminum phosphate, monocalcium phosphate); modified food starch, wheat starch, polyglycerol esters of fatty acids, salt, partially hydrogenated soybean oil, cellulose gum, xanthan gum, maltodextrin, and artificial flavoring)
twelve (12) ounces seltzer water

Cake Preparation:

Place seltzer in mixing bowl and add mix. Mix on low for thirty seconds and increase to medium-high for an additional two (2) minutes. Prepare two (2), eight (8) inch pans by lining with parchment paper and then generously spraying with vegetable cooking spray. Divide mix between pans and bake at three hundred and fifty (350) degrees for forty-five (45) minutes, or until toothpick inserted in center comes out clean.

For cupcakes, line muffin tin with cupcake papers and spray one (1) quick squirt of vegetable oil cooking spray into each paper. Divide batter evenly to make twenty-four (24) cupcakes. Bake cupcakes for twenty-two (22) minutes at three hundred and twenty-five (325) degrees in a convection oven or at three hundred and fifty (350) degrees if convection is not available.

Allow to cool completely before de-panning cake. Be sure cake or cupcakes are completely cool before applying frosting.

### Example 11

### Carrot Cake

In another, non-limiting embodiment, baked food products according to the present invention are prepared using the following ingredients, and according to the following steps:

Cake Ingredients:
one (1) box PILLSBURY brand Carrot Cake Mix [about eighteen and one-quarter (18.25) ounces]
twelve (12) ounces seltzer water

Cake Preparation:

Place seltzer in mixing bowl and add mix. Mix on low for thirty (30) seconds and increase to medium-high for an additional two (2) minutes. Prepare two (2), eight (8) inch pans by lining with parchment paper and then generously spraying with vegetable cooking spray. Divide mix between pans and bake at three hundred and fifty (350) degrees for forty-five (45) minutes, or until toothpick inserted in center comes out clean.

For cupcakes, line muffin tin with cupcake papers and spray one (1) quick squirt of vegetable oil cooking spray into each paper. Divide batter evenly to make twenty-four (24) cupcakes. Bake cupcakes for twenty-two (22) minutes at three hundred and twenty-five (325) degrees in a convection oven or at three hundred and fifty (350) degrees if convection is not available.

Allow to cool completely before de-panning cake. Be sure cake or cupcakes are completely cool before applying frosting.

### Example 12

### Red Velvet Cake

In another, non-limiting embodiment, baked food products according to the present invention are prepared using the following ingredients, and according to the following steps:

Cake Ingredients:
one (1) box DUNCAN HINES brand Red Velvet Cake Mix [about eighteen and one-quarter (18.25) ounces]
twelve (12) ounces seltzer water

Cake Preparation:

Place seltzer in mixing bowl and add mix. Mix on low for thirty (30) seconds and increase to medium-high for an additional two (2) minutes. Prepare two (2), eight (8) inch pans by lining with parchment paper and then generously spraying with vegetable cooking spray.

Divide mix between pans and bake at three hundred and fifty (350) degrees for forty-five (45) minutes, or until toothpick inserted in center comes out clean.

For cupcakes, line muffin tin with cupcake papers and spray one (1) quick squirt of vegetable oil cooking spray into each paper. Divide batter evenly to make twenty-four (24) cupcakes. Bake cupcakes for twenty-two (22) minutes at three hundred and twenty-five (325) degrees in a convection oven or at three hundred and fifty (350) degrees if convection is not available.

Allow to cool completely before de-panning cake. Be sure cake or cupcakes are completely cool before applying frosting.

### Example 13

### Strawberry Cake

In another, non-limiting embodiment, baked food products according to the present invention are prepared using the following ingredients, and according to the following steps:

Cake Ingredients:
one (1) box DUNCAN HINES brand Strawberry Cake Mix [about eighteen and one-quarter (18.25) ounces]
twelve (12) ounces seltzer water

Cake Preparation:

Place seltzer in mixing bowl and add mix. Mix on low for thirty (30) seconds and increase to medium-high for an additional two (2) minutes. Prepare two (2), eight (8) inch pans by lining with parchment paper and then generously spraying with vegetable cooking spray. Divide mix between pans and bake at three hundred and fifty (350) degrees for forty-five (45) minutes, or until toothpick inserted in center comes out clean.

For cupcakes, line muffin tin with cupcake papers and spray one (1) quick squirt of vegetable oil cooking spray into each paper. Divide batter evenly to make twenty-four (24) cupcakes. Bake cupcakes for twenty-two (22) minutes at three hundred and twenty-five (325) degrees in a convection oven or at three hundred and fifty (350) degrees if convection is not available.

Allow to cool completely before de-panning cake. Be sure cake or cupcakes are completely cool before applying frosting.

### Example 14

### Creamsicle Cake

In another, non-limiting embodiment, baked food products according to the present invention are prepared using the following ingredients, and according to the following steps:

Cake Ingredients:
one (1) box DUNCAN HINES brand Orange Cake Mix [about eighteen and one-quarter (18.25) ounces]
twelve (12) ounces seltzer water

Cake Preparation:

Place seltzer in mixing bowl and add mix. Mix on low for thirty (30) seconds and increase to medium-high for an additional two (2) minutes. Prepare two (2), eight (8) inch pans by lining with parchment paper and then generously spraying with vegetable cooking spray. Divide mix between pans and bake at three hundred and fifty (350) degrees for forty-five (45) minutes, or until toothpick inserted in center comes out clean.

For cupcakes, line muffin tin with cupcake papers and spray one (1) quick squirt of vegetable oil cooking spray into each paper. Divide batter evenly to make twenty-four (24) cupcakes. Bake cupcakes for twenty-two (22) minutes at three hundred and twenty-five (325) degrees in a convection oven or at three hundred and fifty (350) degrees if convection is not available.

Allow to cool completely before de-panning cake. Be sure cake or cupcakes are completely cool before applying frosting.

Frost with Butter Cream Icing and garnish with orange zest.

### Example 15

### Pineapple Upside Down Cake

In another, non-limiting embodiment, baked food products according to the present invention are prepared using the following ingredients, and according to the following steps:

Cake Ingredients:
one (1) box DUNCAN HINES brand Pineapple Cake Mix [about eighteen and one-quarter (18.25) ounces]
twelve (12) ounces seltzer water
two-thirds (⅔) cup butter
three-quarters (¾) cup brown sugar
one (1) can pineapple slices
maraschino cherries (enough to fill pineapple holes)

Cake Preparation:

Place seltzer in mixing bowl and add mix. Mix on low for thirty (30) seconds and increase to medium-high for an additional two (2) minutes. Melt butter in saucepan and add brown sugar, combining until smooth. Spread mixture into the bottom of a nine by thirteen (9×13) baking pan. Arrange pineapple rings in on top of mixture and place a cherry in the middle of each pineapple ring. Pour cake mix over pineapple layer, spreading evenly to edges of pan. Bake at three hundred and fifty (350) degrees for forty-five (45) minutes, or until toothpick inserted in center comes out clean.

Allow to cool slightly before de-panning cake onto large rectangular platter.

### Example 16

### Carrot Cake with Cream Cheese Frosting

In another, non-limiting embodiment, baked food products according to the present invention are prepared using the following ingredients, and according to the following steps:

Cake Ingredients:
one (1) box BETTY CROCKER brand Carrot Cake Mix
twelve (12) ounces seltzer water

Cake Preparation:

Pour seltzer into bowl. Add dry cake mix all at once and mix with mixer until smooth, two to three (2-3) minutes on high. Pour half of mixture into each of two (2) greased and floured or parchment lined eight (8) inch round baking pans. Bake at three hundred and fifty (350) degrees for forty (40) minutes, or until cake springs back when touched.

Icing Ingredients:
one-half (½) cup CRISCO brand shortening
one (1) eight (8) ounce block of cream cheese
one-half (½) teaspoon salt
one (1) teaspoon pure vanilla extract
one (1) pound confectioners sugar

Icing Preparation:

Cream CRISCO brand shortening, cream cheese, salt and vanilla until all are well incorporated and creamy. Add powdered sugar and mix until smooth.

Spread icing onto completely cooled cake. Top with second layer and spread icing on entire cake.

### Example 17

### Carrot Cake with Cream Cheese Frosting

In another, non-limiting embodiment, baked food products according to the present invention are prepared using the following ingredients, and according to the following steps:

Cake Ingredients:
one (1) box DUNCAN HINES brand Spice Cake Mix
one (1) cup of shredded carrots
twelve (12) ounces seltzer water

Cake Preparation:

Pour seltzer into bowl. Add dry cake mix all at once and mix with mixer until smooth, two to three (2-3) minutes on high. Add shredded carrots. Pour half of mixture into each of two (2) greased and floured or parchment lined eight (8) inch round baking pans. Bake at three hundred and fifty (350) degrees for forty (40) minutes, or until cake springs back when touched.

Icing Ingredients:
one-half (½) cup CRISCO brand shortening
one (1) eight (8) ounce block of cream cheese
one-half (½) teaspoon salt
one (1) teaspoon pure vanilla extract
one (1) pound confectioners sugar

Icing Preparation:

Cream CRISCO brand shortening, cream cheese, salt and vanilla until all are well incorporated and creamy. Add powdered sugar and mix until smooth.

Spread icing onto completely cooled cake. Top with second layer and spread icing on entire cake.

### Example 18

### Chocolate Cake with Chocolate Buttercream Icing

In another, non-limiting embodiment, baked food products according to the present invention are prepared using the following ingredients, and according to the following steps:

Cake Ingredients:
one (1) box DUNCAN HINES brand Devils Food Cake Mix
twelve (12) ounces of seltzer water

Cake Preparation:

Pour seltzer into bowl. Add dry cake mix all at once and mix with mixer until smooth, two to three (2-3) minutes on high. Pour half of mixture into each of two (2) greased and floured or parchment lined eight (8) inch round baking pans. Bake at three hundred and fifty (350) degrees for forty (40) minutes, or until cake springs back when touched.

Icing Ingredients:
one (1) cup CRISCO brand shortening
four (4) tablespoons water
one-half (½) teaspoon salt
one (1) teaspoon vanilla flavoring/extract
one (1) teaspoon butter flavoring/extract
one-half (½) cup cocoa powder
one (1) pound confectioners sugar
one-quarter (¼) cup chocolate syrup

Icing Preparation:

Cream CRISCO brand shortening, water, salt and flavorings until all are well incorporated. Combine cocoa and powdered sugar, then add dry ingredients a little at a time to wet mixture and mix until smooth. Add chocolate syrup.

Spread icing onto completely cooled cake. Top with second layer and spread icing on entire cake.

### Example 19

### Chocolate Cake with Raspberry Buttercream Icing

In another, non-limiting embodiment, baked food products according to the present invention are prepared using the following ingredients, and according to the following steps:

Cake Ingredients:
one (1) box DUNCAN HINES brand Devil's Food Cake Mix
twelve (12) ounces of seltzer water

Cake Preparation:

Pour seltzer into bowl. Add dry cake mix all at once and mix with mixer until smooth, two to three (2-3) minutes on high. Pour half of mixture into each of two (2) greased and floured or parchment lined eight (8) inch round baking pans. Bake at three hundred and fifty (350) degrees for forty (40) minutes, or until cake springs back when touched.

Icing Ingredients:
one (1) cup CRISCO brand shortening
four (4) tablespoons water
one-half (½) teaspoon salt
one (1) teaspoon vanilla flavoring/extract
one (1) teaspoon butter flavoring/extract
one (1) teaspoon raspberry extract
one (1) pound confectioners sugar

Icing Preparation:

Cream CRISCO brand shortening, water, salt and flavorings until all are well incorporated. Add powdered sugar and mix until smooth.

Spread icing onto completely cooled cake. Top with second layer and spread icing on entire cake.

### Example 20

### German Chocolate Cake

In another, non-limiting embodiment, baked food products according to the present invention are prepared using the following ingredients, and according to the following steps:

Cake Ingredients:
one (1) box DUNCAN HINES brand German Chocolate Cake Mix
twelve (12) ounces of seltzer water

Cake Preparation:

Pour seltzer into bowl. Add dry cake mix all at once and mix with mixer until smooth, two to three (2-3) minutes on high. Pour half of mixture into each of two (2) greased and floured or parchment lined eight (8) inch round baking pans. Bake at three hundred and fifty (350) degrees for forty (40) minutes, or until cake springs back when touched.

Icing Ingredients:
one (1) cup CRISCO brand shortening
four (4) tablespoons water
one-half (½) teaspoon salt
one (1) teaspoon vanilla flavoring/extract
one (1) teaspoon butter flavoring/extract
one-half (½) cup cocoa powder
one (1) pound confectioners sugar
one-quarter (¼) cup chocolate syrup

Topping Ingredients:
three-quarters (¾) cup evaporated milk
one-half (½) cup light brown sugar, firmly packed
one-half (½) cup butter
one (1) can (3½ ounces) flaked coconut, or about one and one-third (1⅓) cups
one (1) cup chopped pecans (optional, depending on whether consumer is avoiding nuts)

Icing Preparation:

Cream CRISCO brand shortening, water, salt and flavorings until all are well incorporated. Add confectioners sugar and mix until smooth.

Spread icing onto completely cooled cake. Sprinkle with coconut and then lightly press coconut into icing. Top with second layer and spread icing on entire cake. Pipe icing around the border of the top layer and then cover the top with the topping.

### Example 21

### Heavenly Coconut Cake

In another, non-limiting embodiment, baked food products according to the present invention are prepared using the following ingredients, and according to the following steps:

Cake Ingredients:
one (1) box DUNCAN HINES brand Coconut Cake Mix
twelve (12) ounces of seltzer water

Cake Preparation:

Pour seltzer into bowl. Add dry cake mix all at once and mix with mixer until smooth, two to three (2-3) minutes on high. Pour half of mixture into each of two (2) greased and floured or parchment lined eight (8) inch round baking pans. Bake at three hundred and fifty (350) degrees for forty (40) minutes, or until cake springs back when touched.

Icing Ingredients:
one (1) cup CRISCO brand shortening
four (4) tablespoons water
one-half (½) teaspoon salt
one (1) teaspoon vanilla flavoring/extract
one (1) teaspoon butter flavoring/extract
two (2) teaspoons coconut extract
one (1) pound confectioners sugar
one-half (½) bag of sweetened coconut

Icing Preparation:

Cream CRISCO brand shortening, water, salt and flavorings until all are well incorporated. Add confectioners sugar and mix until smooth.

Spread icing onto completely cooled cake. Sprinkle with coconut and then lightly press coconut into icing. Top with second layer and spread icing on entire cake. Sprinkle more coconut onto cake, pressing gently into the icing so it stays on the cake.

### Example 22

### Lemon Cake with Raspberry Buttercream Icing

In another, non-limiting embodiment, baked food products according to the present invention are prepared using the following ingredients, and according to the following steps:

Cake Ingredients:
one (1) box DUNCAN HINES brand Lemon Cake Mix
twelve (12) ounces of seltzer water

Icing Ingredients:
one (1) cup CRISCO brand shortening
four (4) tablespoons water
one-half (½) teaspoon salt
one (1) teaspoon vanilla flavoring/extract
one (1) teaspoon butter flavoring/extract
one (1) teaspoon raspberry extract
one (1) pound confectioners sugar

Cake Preparation:

Pour seltzer into bowl. Add dry cake mix all at once and mix with mixer until smooth, two to three (2-3) minutes on high. Pour half of mixture into each of two (2) greased and floured or parchment lined eight (8) inch round baking pans. Bake at three hundred and fifty (350) degrees for forty (40) minutes, or until cake springs back when touched.

Icing Preparation:

Cream CRISCO brand shortening, water, salt and flavorings until all are well incorporated. Add powdered sugar and mix until smooth. Spread icing onto completely cooled cake. Top with second layer and spread icing on entire cake.

### Example 23

### Marble Cake with Buttercream Icing

In another, non-limiting embodiment, baked food products according to the present invention are prepared using the following ingredients, and according to the following steps:

Cake Ingredients:
one-half (½) box DUNCAN HINES brand Yellow Cake Mix
one-half (½) box DUNCAN HINES brand Devil's Food Cake Mix
twelve (12) ounces seltzer water [divided into two equal portions, six (6) ounces each]

Cake Preparation:

Pour six (6) ounces seltzer into bowl. Add one-half (½) box yellow cake mix all at once and mix with mixer until smooth, two to three (2-3) minutes on high. Spread in greased or parchment lined eight (8) inch square pan. Repeat above process with chocolate cake mix and drop by heaping tablespoonfuls onto the prepared yellow cake mix. Swirl with butter knife to create marbled effect. Bake at three hundred and fifty (350) degrees for forty (40) minutes, or until cake springs back when touched. Turn cake out onto plate or cake board.

Icing Ingredients:
one (1) cup CRISCO brand shortening
four (4) tablespoons water
one-half (½) teaspoon salt
one (1) teaspoon vanilla flavoring/extract
one (1) teaspoon butter flavoring/extract
one (1) pound confectioners sugar

Icing Preparation:

Cream CRISCO brand shortening, water, salt and flavorings until all are well incorporated. Add powdered sugar and mix until smooth.

Spread icing onto completely cooled cake.

### Example 24

### Pineapple Upside Down Cake

In another, non-limiting embodiment, baked food products according to the present invention are prepared using the following ingredients, and according to the following steps:

Cake Ingredients:
one (1) box DUNCAN HINES brand Pineapple Cake Mix
twelve (12) ounces seltzer water

Glaze Ingredients:
one (1) stick butter or non-dairy substitute for vegan version
three-quarters (¾) cup brown sugar
one (1) can of pineapple slices
one (1) jar of maraschino cherries

Cake Preparation:

Pour seltzer into bowl. Add dry cake mix all at once and mix with mixer until smooth, two to three (2-3) minutes on high. Melt butter in microwave or on stovetop. Add brown sugar and stir until smooth. Line bottom of nine by thirteen (9×13) pan with parchment paper. Pour butter/sugar mixture into bottom of baking pan and spread out to cover the bottom of the pan evenly. Arrange pineapple slices in bottom of pan, fitting as many as possible without overlapping. Place cherries in spaces and centers of pineapple rings. Pour cake batter on top of this mixture, spreading smooth and covering the pineapple layer completely. Bake at three hundred and fifty (350) degrees for forty (40) minutes or until cake springs back from touch. Turn onto large platter soon after removing from oven.

### Example 25

### Strawberry Cake with Lemon Icing

In another, non-limiting embodiment, baked food products according to the present invention are prepared using the following ingredients, and according to the following steps:

Cake Ingredients:
one (1) box DUNCAN HINES brand Strawberry Cake Mix
twelve (12) ounces of seltzer water

Cake Preparation:

Pour seltzer into bowl. Add dry cake mix all at once and mix with mixer until smooth, two to three (2-3) minutes on high. Pour half of mixture into each of two (2) greased and floured or parchment lined eight (8) inch round baking pans. Bake at three hundred and fifty (350) degrees for forty (40) minutes, or until cake springs back when touched.

Icing Ingredients:
one (1) cup CRISCO brand shortening
four (4) tablespoons water
one-half (½) teaspoon salt
one (1) teaspoon lemon extract
one (1) pound confectioners sugar

Icing Preparation:

Cream CRISCO brand shortening, water, salt and flavoring until all are well incorporated. Add powdered sugar and mix until smooth.

Spread icing onto completely cooled cake. Top with second layer and spread icing on entire cake.

### Example 26

### Super Easy and Delicioso Coffee Cake

In another, non-limiting embodiment, baked food products according to the present invention are prepared using the following ingredients, and according to the following steps:

Cake Ingredients:
one (1) box DUNCAN HINES brand Yellow Mix
twelve (12) ounces of seltzer water

Streusel Topping and Filling Ingredients:
one (1) cup flour
one (1) cup brown sugar
two (2) teaspoons cinnamon
two (2) tablespoons butter, melted

Cake Preparation:

Pour seltzer into bowl. Add dry cake mix all at once and mix with mixer until smooth, two to three (2-3) minutes on high. Grease bunt pan well. Pour half of mixture into bunt and sprinkle half of the streusel topping over it. Pour the remaining half of the cake batter into the pan and top with remaining streusel. Bake at three hundred and fifty (350) degrees for sixty (60) minutes, or until cake springs back when touched. Invert cake onto a plate, and then invert again onto another plate so that the streusel topping ends up on top.

### Example 27

### Yellow Cake with Buttercream Icing

In another, non-limiting embodiment, baked food products according to the present invention are prepared using the following ingredients, and according to the following steps:

Cake Ingredients:
one (1) box DUNCAN HINES brand Yellow Cake Mix
twelve (12) ounces of seltzer water

Icing Ingredients:
one (1) cup CRISCO brand shortening
four (4) tablespoons water
one-half (½) teaspoon salt
one (1) teaspoon vanilla flavoring/extract
one (1) teaspoon butter flavoring/extract
one (1) pound confectioners sugar

Cake Preparation:

Pour seltzer into bowl. Add dry cake mix all at once and mix with mixer until smooth, two to three (2-3) minutes on high. Pour half of mixture into each of two (2) greased and floured or parchment lined eight (8) inch round baking pans. Bake at three hundred and fifty (350) degrees for forty (40) minutes, or until cake springs back when touched.

Icing Preparation:

Cream CRISCO brand shortening, water, salt and flavorings until all are well incorporated. Add powdered sugar and mix until smooth.

Spread icing onto completely cooled cake. Top with second layer and spread icing on entire cake.

### Example 28

### Chocolate Chip Cookies

### Egg-Free, Peanut-Free, Contains Wheat and Soybean Ingredients

In another, non-limiting embodiment, baked food products according to the present invention are prepared using the following ingredients, and according to the following steps:

Cookie Ingredients:
one (1) box [about eighteen and one-quarter (18.25) ounces] PILLSBURY brand Golden Butter Recipe Cake Mix
one-half (½) cup flour
one (1) teaspoon baking soda
one (1) teaspoon salt
three-quarters (¾) cup packed brown sugar
one (1) stick butter, softened
one-quarter (¼) cup SPRITE brand soda
one (1) teaspoon vanilla extract
two-thirds (¾) bag [one and one-third (1⅓) cups]chocolate chips

Cookie Preparation:

Cream together butter, vanilla and brown sugar. Mix dry ingredients in separate bowl. Alternately add dry mixture and SPRITE brand soda to creamed mixture, adding chips/chunks last. Bake on parchment paper for twelve (12) minutes at three hundred (300) degrees in a convection oven [increase to three hundred and twenty-five (325) degrees if convection is unavailable]. Cool and remove from parchment promptly. Makes about four (4) dozen two and one-half (2½) inch cookies.

### Example 29

### Chocolate Chip Cookies

### Egg-Free; Peanut-Free; Contains Wheat and Soybean Ingredients

In another, non-limiting embodiment, baked food products according to the present invention are prepared using the following ingredients, and according to the following steps:

Cookie Ingredients:
one (1) box DUNCAN HINES brand Butter Recipe Yellow Cake Mix [about eighteen and one-quarter (18.25) ounces]
one-half (½) cup packed brown sugar
one-third (⅓) cup butter flavored CRISCO brand shortening
two-thirds (⅔) cup flour
one (1) teaspoon baking soda
one (1) teaspoon salt
one-third (⅓) cup Club Soda
one (1) teaspoon vanilla extract
two-thirds (⅔) bag [one and one-thirds (1⅓) cups] chocolate chips

Cookie Preparation:

Mix 1^{st} six ingredients well. Add club soda mixed with extract. Add chips. Bake on parchment paper for thirteen (13) minutes at three hundred and twenty-five (325) degrees on convection bake. Cool and remove from parchment promptly. Makes about five (5) dozen two and one-half (2½) inch cookies.

### Example 30

### Chocolate Chip Cookies

### Egg-Free; Peanut-Free; Contains Wheat, Milk and Soybean Ingredients

In another, non-limiting embodiment, baked food products according to the present invention are prepared using the following ingredients, and according to the following steps:

Cookie Ingredients:
one (1) box DUNCAN HINES brand Butter Recipe Yellow Cake Mix [about eighteen and one-quarter (18.25) ounces]
one-half (½) cup packed brown sugar
one-half (½) cup butter flavored CRISCO brand shortening
two-thirds (⅔) cup flour
one (1) teaspoon baking soda
one (1) teaspoon salt
one-third (⅓) cup Club Soda
one (1) teaspoon vanilla extract
two-thirds (⅔) bag [one and one-thirds (1⅓) cups] chocolate chips

Cookie Preparation:

Mix 1^{st} six ingredients well. Add club soda mixed with extract. Add chips. Bake on parchment paper for thirteen (13) minutes at three hundred and twenty-five (325) degrees on convection bake. Cool and remove from parchment promptly. Makes about five (5) dozen two and one-half (2½) inch cookies.

### Example 31

### Double Chocolate Chip Cookies

### Egg-Free, Peanut-Free; Contains Wheat, Milk and Soybean Ingredients

In another, non-limiting embodiment, baked food products according to the present invention are prepared using the following ingredients, and according to the following steps:

Cookie Ingredients:
one (1) box DUNCAN HINES brand Devils Food Cake Mix [about eighteen and one-quarter (18.25) ounces]
three-quarters (¾) cup packed brown sugar
one-half (½) cup butter flavored CRISCO brand shortening
one-half (½) cup flour
one (1) teaspoon baking soda
one (1) teaspoon salt
one-half (½) cup Club Soda
one (1) teaspoon vanilla extract
one (1) bag [two (2) cups] white chocolate chips

Cookie Preparation:

Mix 1^{st} six ingredients well. Add club soda mixed with extract. Add chips. Bake on parchment paper for thirteen (13) minutes at three hundred and twenty-five (325) degrees on convection bake. Cool and remove from parchment promptly. Makes about five (5) dozen two and one-half (2½) inch cookies.

### Example 32

### Everything Cookies

### Egg-Free; Peanut-Free; Contains Wheat and Soybean Ingredients

In another, non-limiting embodiment, baked food products according to the present invention are prepared using the following ingredients, and according to the following steps:

Cookie Ingredients:
one (1) box DUNCAN HINES brand Butter Recipe Yellow Cake Mix [about eighteen and one-quarter (18.25) ounces]
one-half (½) cup packed brown sugar
one-half (½) cup butter flavored CRISCO brand shortening
one-half (½) cup flour
one (1) cup oatmeal
one (1) teaspoon baking soda
one (1) teaspoon salt
one-third (⅓) cup+one (1) tablespoon Club Soda
one (1) teaspoon vanilla extract
one-half (½) bag [one and one-third (1⅓) cups] chocolate chips
one-half (½) bag butterscotch chips (without nuts)

Cookie Preparation:

Mix dry ingredients well. Add club soda mixed with extract. Add chips. Bake on parchment paper for twelve (12) minutes at three hundred and twenty-five (325) degrees on convection bake. Cool and remove from parchment promptly. Makes about 4 dozen 50 cent cookies.

### Example 33

### Lemon Cookies w/ Powdered Sugar

In another, non-limiting embodiment, baked food products according to the present invention are prepared using the following ingredients, and according to the following steps:

Cookie Ingredients:
one (1) box lemon cake mix
three-quarters (¾) cup flour
three-quarters (¾) cup 10x (confectioner's/powdered) sugar
one-third (⅓) cup shortening
six (6) ounces SPRITE brand soda
one (1) teaspoon lemon extract

Cookie Preparation:

Combine dry ingredients and mix for one (1) minute on low setting. Add shortening and mix on low until blended in. Add SPRITE brand soda and extract and mix for two to three (2-3) minutes, or until not lumpy. Bake on parchment lined sheets in a three hundred and seventy-five (375) degree oven [that has heated for at least thirty (30) minutes] for exactly twelve (12) minutes. Remove to cooling rack and dust generously with more 10x (confectioner's/powdered) sugar while still warm.

Once given the above disclosure, many other features, modifications, and improvements will become apparent to the skilled artisan. Such features, modifications, and improvements are therefore considered to be part of this invention, without limitation imposed by the example embodiments described herein. Moreover, any word, term, phrase, feature, example, embodiment, or part or combination thereof, as used to describe or exemplify embodiments herein, unless unequivocally set forth as expressly uniquely defined or otherwise unequivocally set forth as limiting, is not intended to impart a narrowing scope to the invention in contravention of the ordinary meaning of the claim terms by which the scope of the patent property rights shall otherwise be determined. All references discussed and disclosed herein are hereby incorporated by reference in their entirety.

What is claimed is:

1. A batter for preparing a baked food product, comprising: (a) flour; (b) a leavening agent; (c) a solid or semi-solid fat component; and (d) a carbonated liquid.

2. A batter for preparing a baked food product according to claim 1, wherein said flour is selected from the group consisting of white flour; wheat flour; corn flour; and gluten-free flour.

3. A batter for preparing a baked food product according to claim 1, wherein said leavening agent is selected from the group consisting of baking soda (sodium bicarbonate); baking powder; dicalcium phosphate; sodium aluminum phosphate; and monocalcium phosphate.

4. A batter for preparing a baked food product according to claim 1, wherein said solid or semi-solid fat component is selected from the group consisting of shortening; vegetable shortening; lard; margarine; coconut oil; palm oil; partially hydrogenated soybean oil; and cottonseed oil.

5. A batter for preparing a baked food product according to claim 1, wherein said carbonated liquid is selected from the group consisting of club soda; seltzer water; beverages with artificial sweeteners; and sugared beverages.

6. A batter for preparing a baked food product according to claim 1, further comprising one or more ingredients selected from the group consisting of sugar; butter; salt; a thickening agent; dried eggs; dried milk; a coloring agent; a flavoring agent; and combinations thereof.

7. A batter for preparing a baked food product according to claim 1, wherein said batter is substantially free of eggs.

8. A batter for preparing a baked food product according to claim 1, wherein said batter is substantially free of milk.

9. A baked food product prepared from said batter according to claim 1.

10. A kit for preparing a baked food product, said kit comprising:
(a) a first package, said first package including a dry ingredients mixture comprising: (i) flour; (ii) a leavening agent; and (iii) a solid or semi-solid fat component; and
(b) a second package, said second package including a carbonated liquid.

11. A kit for preparing a baked food product according to claim 10, wherein said flour is selected from the group consisting of white flour; wheat flour; corn flour; and gluten-free flour.

12. A kit for preparing a baked food product according to claim 10, wherein said leavening agent is selected from the group consisting of baking soda (sodium bicarbonate); baking powder; dicalcium phosphate; sodium aluminum phosphate; and monocalcium phosphate.

13. A kit for preparing a baked food product according to claim 10, wherein said solid or semi-solid fat component is selected from the group consisting of shortening; vegetable shortening; lard; margarine; coconut oil; palm oil; partially hydrogenated soybean oil; and cottonseed oil.

14. A kit for preparing a baked food product according to claim 10, wherein said carbonated liquid is selected from the group consisting of club soda; seltzer water; beverages with artificial sweeteners; and sugared beverages.

15. A kit for preparing a baked food product according to claim 10, wherein said dry ingredients mixture further includes one or more ingredients selected from the group consisting of sugar; salt; a thickening agent; dried eggs; dried milk; a coloring agent; a flavoring agent; and combinations thereof.

16. A kit for preparing a baked food product according to claim 15, wherein said thickening agent is selected from the group consisting of a starch; fruit pectin; xanthan gum; cellulose gum; and guar gum.

17. A kit for preparing a baked food product according to claim 10, wherein said dry ingredients mixture is substantially free of eggs.

18. A kit for preparing a baked food product according to claim 10, wherein said dry ingredients mixture is substantially free of milk.

19. A kit for preparing a baked food product according to claim 10, wherein the ratio of said dry ingredients mixture to said carbonated liquid in said kit is about one and one-half to one (1.5:1).

20. A kit for preparing a baked food product according to claim 10, wherein the ratio of said dry ingredients mixture to said carbonated liquid in said kit is about two and one-half to one (2.5:1).

21. A method for preparing a baked food product, comprising the steps:
(a) mixing (i) flour; (ii) a leavening agent; (iii) a solid or semi-solid fat component; and (iv) a carbonated liquid, to prepare a batter; and
(b) baking said batter of step (a).
